(19) United States
(12) Patent Application Publication
(10) Pub. No.: US 2017/0134650 A1
(43) Pub. Date: May 11, 2017

(54) SURROUNDINGS DETECTION DEVICE FOR A VEHICLE AND METHOD FOR DETECTING AN IMAGE WITH THE AID OF A SURROUNDINGS DETECTION DEVICE

(71) Applicant: Robert Bosch GmbH, Stuttgart (DE)

(72) Inventor: Ulrich Seger, Leonberg-Warmbronn (DE)

(21) Appl. No.: 15/257,327

(22) Filed: Sep. 6, 2016

(30) Foreign Application Priority Data
Sep. 10, 2015 (DE) 10 2015 217 253.8

(51) Int. Cl. H04N 5/232; H04N 7/18; H04N 5/225; G06K 9/00; H04N 9/04

(52) U.S. Cl. CPC H04N 5/23232; G06K 9/00791; H04N 9/045; H04N 5/2258; H04N 7/181; H04N 2209/047; G05D 1/0238

(57) ABSTRACT

A surroundings detection device for a vehicle includes a color sensor having a color pixel matrix and a monochrome sensor having a monochrome pixel matrix, the color sensor and the monochrome sensor being oriented to each other so that an object point of an object detectable by the color pixel matrix and the monochrome pixel matrix is projected onto a matrix point of the color pixel matrix and onto a matrix point of the monochrome pixel matrix which is offset with respect to the matrix point of the color pixel matrix by an offset value.

### RELATED APPLICATION INFORMATION

The present application claims priority to and the benefit of German patent application no. 10 2015 217 253.8, which was filed in Germany on Sep. 10, 2015, the disclosure of which is incorporated herein by reference.

### FIELD OF THE INVENTION

The present invention is directed to a device and to a method according to the definition of the species in the independent claims. The present invention also relates to a computer program.

### BACKGROUND INFORMATION

To be able to cover large viewing angles and detect smaller objects even at a larger distance with sufficiently high resolution, cameras may be implemented for surroundings detection in vehicles having sensor resolutions which increase proportionally with the square of an angle enlargement of the viewing angle.

Furthermore, approaches involving multiple cameras for increasing the field of vision are known, the cameras generally being evaluated separately from each other.

### SUMMARY OF THE INVENTION

Against this background, the approach described here introduces a surroundings detection device for a vehicle, a method for detecting an image with the aid of a surroundings detection device for a vehicle, a control unit which furthermore uses this method, and finally a corresponding computer program as recited in the main claims. The measures listed in the dependent claims allow advantageous refinements of and improvements on the device described in the independent claim.

A surroundings detection device for a vehicle is introduced, the surroundings detection device including the following features:

a color sensor having a color pixel matrix; and
a monochrome sensor having a monochrome pixel matrix, the color sensor and the monochrome sensor being oriented to each other in such a way that an object point of an object detectable by the color pixel matrix and the monochrome pixel matrix is projected onto a matrix point of the color pixel matrix and onto a matrix point of the monochrome pixel matrix which is offset with respect to the matrix point of the color pixel matrix by an offset value.

A color sensor may be understood to mean a photo sensor coated with a color filter, or color filter array. In particular, the color filter may be a multispectral color filter for filtering light of different spectral ranges. A color pixel matrix and a monochrome pixel matrix may each be understood to mean an orthogonal matrix, for example, made up of a plurality of pixels abutting each other. A monochrome sensor may be understood to mean a sensor for detecting monochromatic light. The color pixel matrix and the monochrome pixel matrix may be implemented on a shared carrier, for example. An object point may be understood to mean a real point which is to be depicted, of an object to be detected. A matrix point may be understood to mean a location of the color or monochrome pixel matrix on which the object point may be depicted, for example using suitable optical aids. The offset value may be ascertained, for example, based on a distance between center points of adjoining pixels of the color pixel matrix. This distance may also be referred to as the lattice constant.

The approach described here is based on the finding that it is possible, by superimposing a color pixel matrix and a monochrome pixel matrix and by systematically utilizing a shared covered area, to considerably increase the resolution of a vehicle camera. In this way, in turn, the number of object features detectable by the vehicle camera may be increased. A further advantage of such a surroundings detection device is that, as a result of the superimposition and simultaneous evaluation of the two pixel matrices, the amounts of data in the transmission and processing of image data may be kept low despite the increased resolution, which in turn may favorably affect the energy consumption of the surroundings detection device. Furthermore, optical losses may thus be reduced, which improves the discrimination capability of the system.

It is particularly advantageous when the surroundings detection device includes, for example, a color sensor having more than three color channels, in particular four color channels such as blue, red, green and infrared, and a monochrome sensor having an accordingly higher luminance resolution than the color sensor. In this way, it is possible to calculate an image which, in addition to an increased contrast resolution, has a highly differentiated color resolution and is thus particularly well-suited for object identification.

According to one specific embodiment, the offset value may represent an offset of the matrix point of the monochrome pixel matrix in the x direction and/or y direction with respect to an outer margin of the color pixel matrix. The offset between the two matrix points may thus be defined in multiple directions. Such an offset value may additionally be ascertained very easily and precisely.

It is furthermore advantageous if the offset value is formed by dividing a distance between center points of pixels of the color pixel matrix by an even number. The distance may be interpreted as a lattice constant defining a regular structure of the color pixel matrix, for example. As a result of this specific embodiment, it is possible, for example, to very easily calculate the offset between the two matrix points in the x or y direction.

Furthermore, an angular resolution of the color pixel matrix and an angular resolution of the monochrome pixel matrix may deviate from each other.

In particular, the angular resolution of the monochrome pixel matrix and the angular resolution of the color pixel matrix may be in an even-numbered ratio to each other. In this way, the surroundings detection device may detect objects with different resolutions. For example, the particular detection areas of the two pixel matrices may overlap in an overlapping area, the overlapping area having a particularly high resolution.

It is also advantageous when the surroundings detection device includes a prism for projecting the object point onto the color pixel matrix and the monochrome pixel matrix. In addition or as an alternative, the surroundings detection device may include a first optical device for projecting the object point onto the color pixel matrix or a second optical device for projecting the object point onto the monochrome pixel matrix. An optical device may be understood to mean a camera lens, for example. The first or second optical device may include one lens, one mirror or several such lenses or mirrors, for example. In this way, the object point may be directed precisely at the particular matrix point with comparatively low complexity.

According to one further specific embodiment, the color pixel matrix may include at least one pixel array made up of four pixels. At least three of the four pixels may each be assigned to another color. In particular, at least one of the four pixels may be assigned to the infrared range or a spectrally broadband but NIR-blocked. A pixel array may be understood to mean a light-sensitive photo cell or photo area of the color sensor which is composed of the four pixels. For example, the pixel array may be square or rectangular, depending on the shape of the pixels. The color pixel matrix may be implemented as an RGBI matrix, for example (RGBI=Red, Green, Blue, Intensity or RGC_{bb}C_{wo}_{_}ₙᵢᵣ=Red, Green, Clear_{broadband}, Clear_{without near infrared}). This specific embodiment allows the surroundings detection device to be implemented with a very high color resolution or with an extended spectral resolution.

Moreover, the surroundings detection device may include a further image sensor having a further pixel matrix. The further image sensor may be oriented in such a way that the object point is furthermore projected onto a matrix point of the further pixel matrix. The further image sensor may include a polarizing filter for detecting a polarization value assigned to the matrix point of the further pixel matrix. With the aid of the polarization value, an image having an improved contrast may be generated.

The polarizing filter may be configured to filter light in at least two different polarization directions. For this purpose, the polarizing filter may be configured, for example, as a polarization matrix having at least one polarization field made up of four polarization elements which are each assigned to a pixel of the further pixel matrix. This enables a very precise detection of the polarization value.

Furthermore, the approach described here creates a method for detecting an image with the aid of a surroundings detection device according to one of the above specific embodiments, the method including the following steps:

reading in a signal of the color sensor representing the object point and a signal of the monochrome sensor representing the object point; and
generating the image using the signal of the color sensor and the signal of the monochrome sensor.

According to one specific embodiment, a further polarization value detected by a further image sensor may be read in in the step of reading in. In the step of generating, the image may furthermore be generated using the polarization value. With the aid of the polarization value, a contrast-lowering effect of polarization-rotating surfaces may be reduced, and thus the image quality of the image be improved.

This method may be implemented in software or hardware or in a mixed form made up of software and hardware, for example in a control unit.

The approach described here furthermore creates a control unit which is configured to carry out, activate or implement the steps of one variant of a method described here in corresponding devices. The object of the present invention may also be achieved quickly and efficiently by this embodiment variant of the present invention in the form of a control unit.

A control unit may presently be understood to mean an electrical device which processes sensor signals and outputs control and/or data signals as a function thereof. The control unit may include an interface which may be configured as hardware and/or software. In the case of a hardware design, the interfaces may, for example, be part of a so-called system ASIC which includes a wide variety of functions of the control unit. However, it is also possible for the interfaces to be separate integrated circuits, or to be at least partially made up of discrete elements. In the case of a software design, the interfaces may be software modules which are present on a microcontroller, for example, in addition to other software modules.

In addition, a computer program product or computer program is advantageous, having program code which may be stored on a machine-readable carrier or storage medium such as a semiconductor memory, a hard disk memory or an optical memory, and which is used to carry out, implement and/or activate the steps of the method according to one of the specific embodiments described above, in particular if the program product or program is executed on a computer or a device.

Exemplary embodiments of the present invention are shown in the drawings and are described in greater detail in the following description.

### BRIEF DESCRIPTION OF THE DRAWINGS

FIG. 1 shows a schematic representation of a surroundings detection device according to one exemplary embodiment.

FIG. 2 shows a schematic representation of a superposition of a color pixel matrix and a monochrome pixel matrix from FIG. 1 according to one exemplary embodiment.

FIG. 3 shows a schematic representation of a superposition of a color pixel matrix and a monochrome pixel matrix from FIG. 1 according to one exemplary embodiment.

FIG. 4 shows a schematic representation of a surroundings detection device according to one exemplary embodiment.

FIG. 5 shows a schematic representation of a surroundings detection device including a further image sensor according to one exemplary embodiment.

FIG. 6 shows a schematic representation of a further image sensor according to one exemplary embodiment.

FIG. 7 shows a schematic representation of a surroundings detection device according to one exemplary embodiment.

FIG. 8 shows a schematic representation of a superposition of a color pixel matrix and a monochrome pixel matrix from FIG. 7 according to one exemplary embodiment.

FIG. 9 shows a flow chart of a method according to one exemplary embodiment.

### DETAILED DESCRIPTION

In the following description of favorable exemplary embodiments of the present invention, identical or similar reference numerals are used for similarly acting elements shown in the different figures, and a repeated description of these elements is dispensed with.

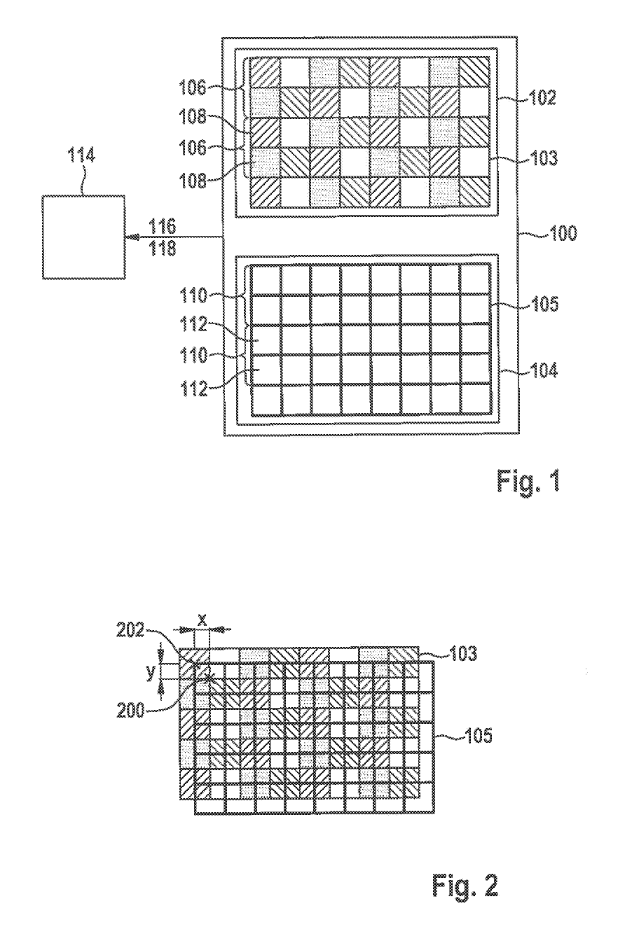

FIG. 1 shows a schematic representation of a surroundings detection device 100 according to one exemplary embodiment. Surroundings detection device 100 includes a color sensor 102 having a color pixel matrix 103 and a monochrome sensor 104 having a monochrome pixel matrix 105. According to this exemplary embodiment, the two sensors 102, 104 are situated on a shared base carrier. The two matrices 103, 105 each have a checkerboard-like structure. By way of example, color pixel matrix 103 is configured with a multitude of square color pixel arrays 106, each being composed of four color pixels 108. Four color pixels 108 of each color pixel array 106 are each assigned to a different color, for example. Monochrome pixel matrix 105 is also composed of a multitude of square monochrome pixel arrays 110 made up of four monochrome pixels 112 each. The two matrices 103, 105 have the same format according to FIG. 1.

For example, color sensor 102 is implemented with an RGBI pattern sensitive to near infrared (NIR). The pixels of monochrome sensor 104 are configured to be spectrally broadband from blue to infrared, for example.

The two matrices 103, 105 are oriented to each other on the base carrier in such a way that an object point of an object to be detected is projected both onto color pixel matrix 103 and onto monochrome pixel matrix 105. The projection of the object point onto the two matrices 103, 105 takes place, for example, with the aid of a suitable lens of surroundings detection device 100, as it is described in greater detail hereafter. The projection takes place in such a way that the object point is projected onto a location of the monochrome pixel matrix 105 which, compared to a location onto which the object point is projected on color pixel matrix 103, is offset by a certain offset value, as is described in greater detail hereafter based on FIG. 2.

According to this exemplary embodiment, surroundings detection device 100 is connected to a control unit 114 which is configured to receive a signal 116 of color sensor 102 representing the object point and a signal 118 of monochrome sensor 104 representing the object point, and to generate an image using the two signals 116, 118.

FIG. 2 shows a schematic representation of a superposition of a color pixel matrix 103 and a monochrome pixel matrix 105 from FIG. 1 according to one exemplary embodiment. FIG. 2 shows the two matrices 103, 105 superimposed to clarify the offset between the two locations onto which the object point is projected in each case. It is apparent, for example, that the object point according to this exemplary embodiment is projected onto a matrix point 200 of monochrome pixel matrix 105 which is offset with respect to a matrix point 202 of color pixel matrix 103 assigned to the object point both in the x direction and also in the y direction. By way of example, the offset value by which the two matrix points 200, 202 are offset from each other in the x and y directions is half a distance between the center points of two adjoining pixels of color pixel matrix 103 here. An outer margin of color pixel matrix 103 serves as a reference point for setting the offset, for example.

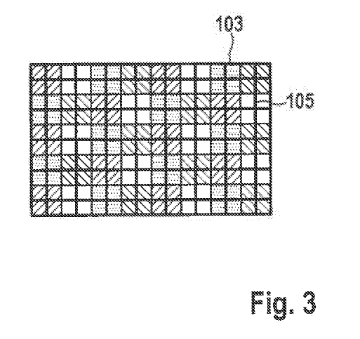

FIG. 3 shows a schematic representation of a superposition of a color pixel matrix and a monochrome pixel matrix from FIG. 1 according to one exemplary embodiment. FIG. 3 shows an image resolution achieved with the aid of the offset between the two matrices 103, 105.

For example, an image having four times the resolution in luminance, also referred to as super resolution, and one time the resolution in chrominance results when a weighted luminance value is calculated in each case from a quadruple made up of RGBI and placed onto an interstitial site.

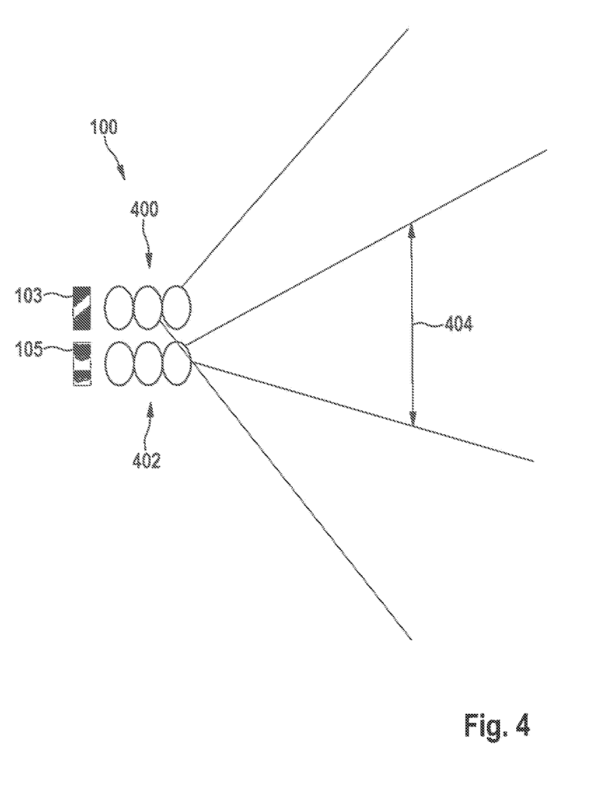

FIG. 4 shows a schematic representation of a surroundings detection device 100 according to one exemplary embodiment. Surroundings detection device 100 is a surroundings detection device as it is described above based on FIGS. 1 through 3, for example. According to this exemplary embodiment, surroundings detection device 100 includes a first optical device 400 for projecting the object point onto color pixel matrix 103 and a second optical device 402 for projecting the object point onto monochrome pixel matrix 105. Second optical device 402 has a smaller aperture angle than first optical device 400. By way of example, the aperture angle of first optical device 400 according to FIG. 4 is twice as large as the aperture angle of second optical device 402. The two optical devices 400, 402 are situated in such a way that their detection areas defined by their respective aperture angle overlap in an overlapping area 404 in which the resolution is several times greater than outside overlapping area 404.

Surroundings detection device 100 may have a variable angular resolution with respect to a field angle. It is particularly advantageous if the color sensor and the monochrome sensor have different resolutions and an even-numbered multiple is maintained between the particular resolutions. By way of example, the monochrome sensor has an angular resolution of 28 pixels per degree, while the color sensor has an angular resolution of only 14 pixels per degree.

It is possible, for example, to combine a color sensor having 1980 times 1200 pixels with a monochrome sensor having 990 times 600 pixels. The particular viewing axes are oriented in such a way that overlapping area 404 is situated in an angle range in which, depending on the application, a particularly high resolution is required for object identification.

In the case of an appropriately matched lens, the achieved luminance resolution in this area results as 1980 times 1200 luminance values and an angle coverage of plus/minus 35 degrees at 28 pixels per degree. The resolution in the non-overlapped area is ideally 14 pixels per degree and an angle coverage of approximately plus/minus 70 degrees.

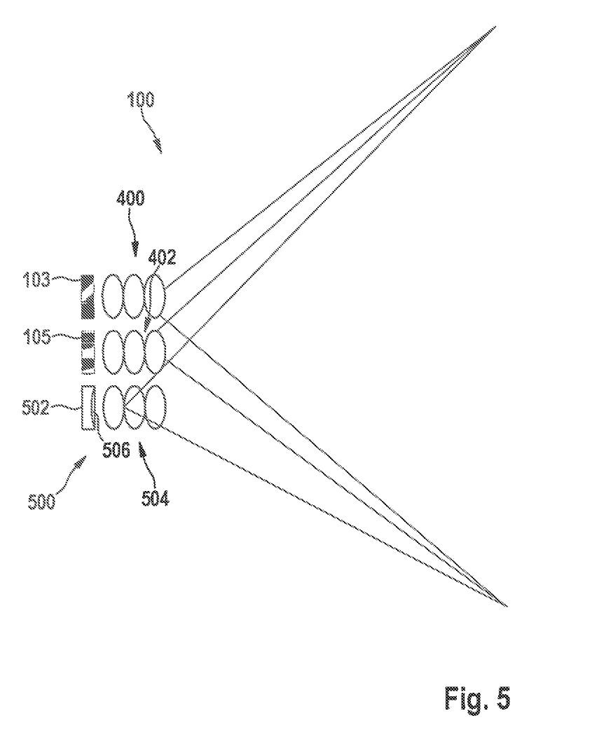

FIG. 5 shows a schematic representation of a surroundings detection device 100 including a further image sensor 500 according to one exemplary embodiment. In contrast to FIG. 4, surroundings detection device 100 shown in FIG. 5 includes a further image sensor 500 having a further pixel matrix 502, in addition to the color and monochrome sensors. A further optical device 504 is configured similarly to first optical device 400 and to second optical device 402 to project the object point furthermore onto further pixel matrix 502. Further pixel matrix 502 includes a polarizing filter 506, which is used to detect a polarization value assigned to the object point when a light beam representing the object point strikes a corresponding matrix point of further pixel matrix 502.

According to one exemplary embodiment, surroundings detection device 100 is implemented as a super resolution multicam system having an M camera, which includes the monochrome sensor and a regular lens as second optical device 402. An aperture angle of the regular lens is approximately plus/minus 50 to 60 degrees, for example. Compared to a C camera, the M camera is equipped with a multispectral color filter array as the color sensor, and an optional P camera including a structured polarizing filter 506, and a regular or wide angle lens as further optical device 504.

The resolution in pixels per degree of the M camera is equal to or higher than that of the C camera and of the P camera. The C camera is configured with a multispectral color sensor, in particular an RGBI color sensor, for example. In contrast, the M camera has a broadband design. For example, the image sensor of the P camera is implemented as a polarizing filter array, whose filters are able to filter light in four different polarization directions. The four polarization directions may each be rotated 90 degrees in relation to each other.

The camera system thus configured is suitable for differentiating objects at a large distance in a limited angle range, and for differentiating closer objects over a large angle range.

When the two sensor modules are assembled in the form of the color sensor and the monochrome sensor, the respective camera heads of the two sensors are oriented to each other, for example, in such a way that the projection of the pixel matrix into an object space is shifted by half a lattice constant in relation to color pixel matrix 103.

The luminance channel of the color sensor may now be utilized to interpolate a signal of the monochrome sensor in interim values, and to assign an undersampled chrominance value to each luminance value of the monochrome sensor. The result is the super-resolved luminance image including low resolution chrominance information. With the aid of additional assignment of the polarization values, it is possible to generate an image which is super-resolved according to luminance, broken down into multiple spectral channels and resolved according to the polarization direction and which contains considerably more differentiating object features than a higher resolution RGB camera image.

Due to the offset sampling, a considerably higher resolution image may be generated than would be possible by an orthogonal matrix having double the resolution, at the same resolution of the two sensors, by doubling of the pixel count. The two nested lattices of color pixel matrix 102 and of monochrome pixel matrix 105 together result in a hexagonal sampling pattern which is less prone to moiré effects than an orthogonal pattern and, with the aid of interpolation of the pixel intermediate positions, may be brought to four times the resolution in that the mean value of two adjoining pixels of color pixel matrix 103 in each case yields an interstitial site in the image of the monochrome sensor.

If the two sensors are moreover synchronized with each other, for example by a shared pixel frequency supply, and if this is selected in such a way that the integration time of the two sensors takes place 90-degree phase shifted, movement or modulation artefacts, as they may occur, for example, during the sampling of variable message signs, may be largely corrected by a suitable calculation.

In the case of an expansion with a polarizing filter camera, which, for example, includes sensors having a matrix made up of polarizing filters rotated in each case by 90 degrees, it is possible to represent objects with more differentiation if the pixels contributing to the optimal contrast, for example, are utilized to amplify the gray scale values of a monochrome image.

Such a superposition of a monochrome and a spectrally resolved camera image thus enables a considerably higher contrast resolution than a camera having a conventional color filter array.

Depending on the specific embodiment, each of the sensors of surroundings detection device 100 is equipped with its own lens. As an alternative, each sensor receives the same depiction of a shared lens via a prism.

According to one exemplary embodiment, the angle resolutions of the two sensor modules in overlapping area 404 are at a fixed, in particular even-numbered, ratio to each other. The sensor modules, i.e., the sensor and the lens, are oriented in such a way that the particular lattices of the sensors are shifted by a value G/n in relation to each other, G representing a lattice constant of the sensor, i.e., a distance between the center points of adjoining pixels of the sensors, and n being an even number.

Optionally, the sensors are synchronized with each other, in particular being activatable phase shifted by 90-degrees during the integration time.

Optionally, surroundings detection device 100, in addition to the spectral filtering, includes a polarizing filtering in the form of polarizing filter 506, which is used to detect a polarization direction.

An image generated from the individual signals of the sensors thus has a luminance resolution which, depending on the specific embodiment, is four times as high as a respective individual resolution of the sensors, for example. For example, using two sensors having a resolution of 1280 times 800 pixels each (together approximately 2 megapixels), it is thus possible to generate an image that corresponds to the image of an orthogonal 4-megapixel sensor, and moreover has a higher contrast resolution capability.

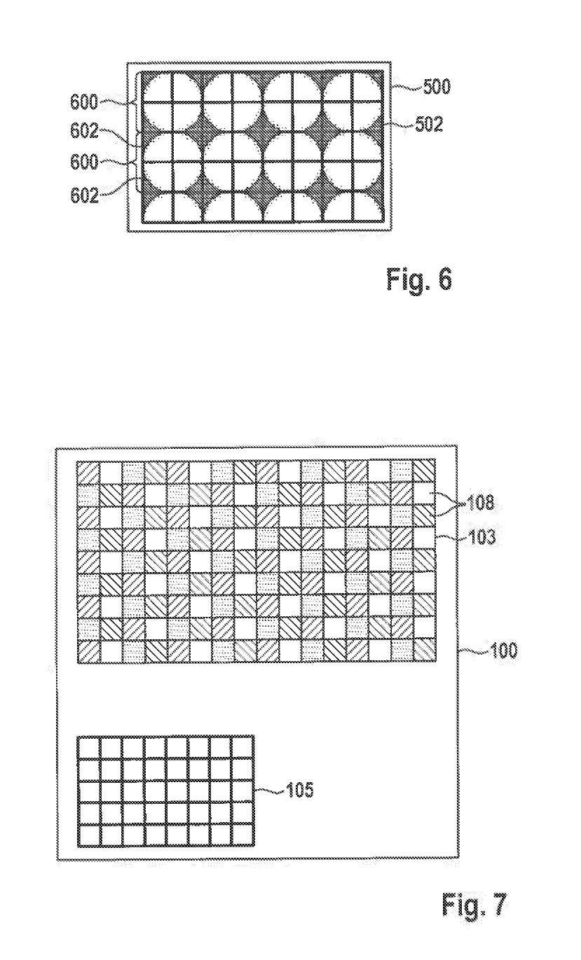

FIG. 6 shows a schematic representation of a further image sensor 500 according to one exemplary embodiment. According to this exemplary embodiment, further pixel matrix 502 is implemented with a polarizing filter made up of a multitude of square polarization fields 600, composed of four polarization elements 602 each. For example, one pixel of further pixel matrix 502 is assigned to each of polarization elements 602. Furthermore, the individual positions of the pixels of further pixel matrix 502 may correspond to the positions of the color pixels of color pixel matrix 103.

According to one exemplary embodiment, further pixel matrix 502 includes filter structures microstructured pixel by pixel as the polarizing filter to be able to distinguish between four different polarization directions, such as 45, 135, 225 or 315 degrees. In this way, by superposition of a respective certain dominant polarization direction with the luminance values, it is possible to generate an image which, per lattice position of the super-resolved lattice, outputs one luminance value, four spectral characteristic values and one main polarization value.

With the aid of the polarization value, in particular a reduction of a contrast-lowering effect of polarization-rotating surfaces such as water, glass or translucent materials may be achieved by appropriately weighting the luminance values of the color sensor with the respective contrast-richest luminance values of further image sensor 500.

FIG. 7 shows a schematic representation of a surroundings detection device 100 according to one exemplary embodiment. In contrast to FIG. 1, surroundings detection device 100 according to FIG. 7 is implemented with a color pixel matrix 103, which compared to monochrome pixel matrix 105 has a considerably higher number of color pixels 108 and thus an accordingly higher resolution.

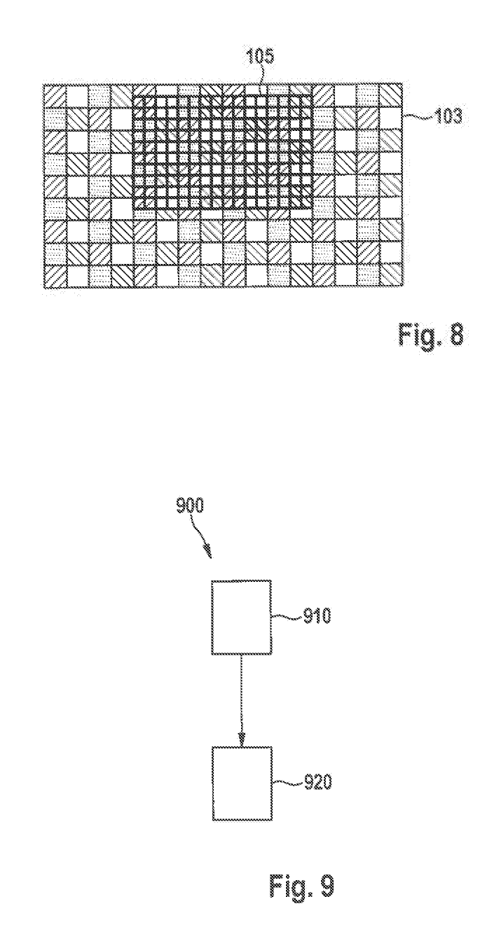

FIG. 8 shows a schematic representation of a superposition of a color pixel matrix 103 and a monochrome pixel matrix 105 from FIG. 7 according to one exemplary embodiment.

FIG. 9 shows a flow chart of a method 900 for detecting an image with the aid of a surroundings detection device according to one exemplary embodiment. Method 900 may be carried out in connection with a surroundings detection device described above, for example. Method 900 includes a step 910 in which a signal of the color sensor representing the object point and a signal of the monochrome sensor representing the object point are read in. In a step 920, a high resolution image is generated using the two signals.

According to one optional exemplary embodiment, in step 910 furthermore a polarization value detected by a further image sensor of the surroundings detection device with respect to the object point is read in. Thereupon, in step 920, the image is furthermore generated using the polarization value.

If one exemplary embodiment includes an “and/or” linkage between a first feature and a second feature, this should be read in such a way that the exemplary embodiment according to one specific embodiment includes both the first feature and the second feature, and according to an additional specific embodiment includes either only the first feature or only the second feature.

1-13. (canceled)

14. A surroundings detection device for a vehicle, comprising:
a color sensor having a color pixel matrix; and
a monochrome sensor having a monochrome pixel matrix;
wherein the color sensor and the monochrome sensor are oriented to each other so that an object point of an object detectable by the color pixel matrix and the monochrome pixel matrix is projected onto a matrix point of the color pixel matrix and onto a matrix point of the monochrome pixel matrix which is offset with respect to the matrix point of the color pixel matrix by an offset value.

15. The surroundings detection device of claim 14, wherein the offset value represents an offset of the matrix point of the monochrome pixel matrix in the x direction and/or y direction with respect to an outer margin of the color pixel matrix.

16. The surroundings detection device of claim 14, wherein the offset value is formed by dividing a distance between center points of pixels of the color pixel matrix by an even number.

17. The surroundings detection device of claim 14, wherein an angular resolution of the color pixel matrix and an angular resolution of the monochrome pixel matrix deviate from each other.

18. The surroundings detection device of claim 14, further comprising:
a prism for projecting the object point onto the color pixel matrix and the monochrome pixel matrix and/or a first optical device for projecting the object point onto the color pixel matrix and/or a second optical device for projecting the object point onto the monochrome pixel matrix.

19. The surroundings detection device of claim 14, wherein the color pixel matrix includes at least one pixel array made up of four pixels, at least three of the four pixels each being assigned to another spectral range.

20. The surroundings detection device of claim 14, further comprising:
a further image sensor having a further pixel matrix, wherein the further image sensor is oriented so that the object point is furthermore projected onto a matrix point of the further pixel matrix, the further image sensor including a polarizing filter for detecting a polarization value assigned to the matrix point of the further pixel matrix.

21. The surroundings detection device of claim 20, wherein the polarizing filter is configured to filter light in at least two different polarization directions.

22. A method for detecting an image with the aid of a surroundings detection device, the method comprising:
reading in a signal of a color sensor representing the object point and a signal of a monochrome sensor representing the object point; and
generating the image using the signal of the color sensor and the signal of the monochrome sensor;
wherein the surroundings detection device is for a vehicle and includes:
the color sensor having a color pixel matrix; and
the monochrome sensor having a monochrome pixel matrix;
wherein the color sensor and the monochrome sensor are oriented to each other so that an object point of an object detectable by the color pixel matrix and the monochrome pixel matrix is projected onto a matrix point of the color pixel matrix and onto a matrix point of the monochrome pixel matrix which is offset with respect to the matrix point of the color pixel matrix by an offset value.

23. The method of claim 22, wherein a further polarization value detected by a further image sensor is read in in the reading in, the image furthermore being generated using the polarization value in the step of generating.

24. A control unit, comprising:
a control arrangement configured for detecting an image with the aid of a surroundings detection device, by performing the following:
reading in a signal of a color sensor representing the object point and a signal of a monochrome sensor representing the object point; and
generating the image using the signal of the color sensor and the signal of the monochrome sensor;
wherein the surroundings detection device is for a vehicle and includes:
the color sensor having a color pixel matrix; and
the monochrome sensor having a monochrome pixel matrix;
wherein the color sensor and the monochrome sensor are oriented to each other so that an object point of an object detectable by the color pixel matrix and the monochrome pixel matrix is projected onto a matrix point of the color pixel matrix and onto a matrix point of the monochrome pixel matrix which is offset with respect to the matrix point of the color pixel matrix by an offset value.

25. The control unit of claim 24, wherein the offset value represents an offset of the matrix point of the monochrome pixel matrix in the x direction and/or y direction with respect to an outer margin of the color pixel matrix.

26. A computer readable medium having a computer program, which is executable by a processor, comprising:
a program code arrangement having program code for detecting an image with the aid of a surroundings detection device, by performing the following:
reading in a signal of a color sensor representing the object point and a signal of a monochrome sensor representing the object point; and
generating the image using the signal of the color sensor and the signal of the monochrome sensor;
wherein the surroundings detection device is for a vehicle and includes:
the color sensor having a color pixel matrix; and
the monochrome sensor having a monochrome pixel matrix;
wherein the color sensor and the monochrome sensor are oriented to each other so that an object point of an object detectable by the color pixel matrix and the monochrome pixel matrix is projected onto a matrix point of the color pixel matrix and onto a matrix point of the monochrome pixel matrix which is offset with respect to the matrix point of the color pixel matrix by an offset value.

27. The surroundings detection device of claim 14, wherein an angular resolution of the color pixel matrix and an angular resolution of the monochrome pixel matrix deviate from each other, in particular the angular resolution of the monochrome pixel matrix and the angular resolution of the color pixel matrix being in a favorable, even-numbered, ratio to each other.

28. The surroundings detection device of claim 14, wherein the color pixel matrix includes at least one pixel array made up of four pixels, at least three of the four pixels each being assigned to another spectral range, in particular at least one of the four pixels, including a broadband spectral channel and an IR block filter.
